(19) United States
(12) Patent Application Publication
(10) Pub. No.: US 2003/0039265 A1
(43) Pub. Date: Feb. 27, 2003

(54) ISDN monitoring

(76) Inventors: Martti Yrjana, Tupos (FI); Esa-Petri Inkero, Oulu (FI); Juha Pajuvirta, Helsinki (FI); Sami Kivilaakso, Veikkola (FI); Eero Koivisto, Helsinki (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/208,782

(22) Filed: Aug. 1, 2002

Related U.S. Application Data
(63) Continuation of application No. PCT/FI01/00156, filed on Feb. 16, 2001.

(30) Foreign Application Priority Data
Feb. 18, 2000 (FI) 2000 0385

(51) Int. Cl. H04L 12/66

(52) U.S. Cl. 370/463; 370/465

(57) ABSTRACT

The invention relates to a method and a system for the dividing of a connection channel of an ISDN network between a packet connection channel and other traffic. In dividing, monitoring is utilized which enables one to find out the free channels and the engaged packet connection channels.

The invention relates to telecommunication systems. In particular, the invention relates to a method in which a packet connection channel is allocated to a piece of packet information of the ISDN network (ISDN, Integrated Services Digital Network) by monitoring.

### PRIOR ART

The use of an ISDN network in telecommunication is becoming common. The basic access of an ISDN network contains one signaling channel, the D-channel, with the transfer rate of 16 kbit/s and two B-channels with the total transfer rate of 128 kbit/s. The primary rate access of an ISDN network contains one D-channel with the transfer rate of 64 kbit/s, and 30 B-channels. The theoretical maximum transfer rate of an ISDN interface visible to the user is 1,920 kbit/s. The ISDN interface consists of a series of the ITU-T and ETSI standards. The network terminal is usually the digital telephone or the network adapter of the ISDN network, if the ISDN interface is connected to a computer.

Usually a telecommunication system consists of telephone exchanges, concentrators, subscriber modules, a subscriber, and link connections. The concentrator, e.g. the remote subscriber stage (RSS, Remote Subscriber Stage) has been connected by one ore more 2 Mbit/s link connections to the exchange. The concentrator is used to concentrate the traffic between the subscribers and the exchange. The ratio of subscribers and concentrators has been estimated according to the amount of traffic of subscribers. To the concentrator, for instance, it is possible to connect 100 subscribers who have 30 speech time slots available for use that are implemented by a pulse code modulation (PCM, Pulse Code Modulation) cable. The use of pulse code modulation cables is expensive, so the use of the cable, i.e. the speech time slots, is tried to optimize. The optimization is done by estimating in advance the amount of the traffic to be transmitted. And based on this, the pulse code modulation cables are being allocated. The modulation is used to mean the attaching of a piece of data either to an electronic or optical carrier wave.

The packet mode bearer service (PMBS, Packet Mode Bearer Service) of the ISDN network, which has been defined in the standards ETS 300 099, ETS 300 048 and ETS 300 049, provides the subscriber with a packet-switched data transfer, in which case the subscriber may send packet-formed information up to 9,6 kbit/s at the maximum. In this way, one time slot of a pulse code modulation cable is sufficient enough to be used by six subscribers simultaneously at the rate mentioned above. Usually the data transfer connections between the exchange and the concentrator are protected in such a way that the signaling time slots transfer to another pulse code modulation cable, if the pulse code modulation cable used in signaling is broken.

The offering of a packet mode bearer service for D-channel (PMBS-D, Packet Mode Bearer Service for D-channel) for subscribers means the allocation of additional channels between the exchange and the subscriber module for the data transfer of a piece of packet-formed data. The offering of a packet data connection and the protection of packet data connections means a significant decrease in the capacity of speech time slots, e.g. between the exchange and the concentrator, if we assume that the amount of the pulse code modulation cables is not increased.

In a packet-switched data communication, the piece of data to be transmitted, such as a file, is divided into small parts, packets, which are efficient to transfer and route in a telecommunication network. To the packets, an individualized serial number and a piece of address data are attached, after which the packets are left to be transported by the telecommunication network. The packet-switched data transfer is connectionless, so no direct connection is established between the sender and the recipient, unlike in the circuit-switched data transfer. In the packet-switched data transfer, it is just seen to that the packets are transferred along some telecommunication route to the recipient, in which case the packets may arrive also in the wrong order at the destination. For arranging the packets in the right order, it is possible to use, e.g. the transfer control protocol (TCP, Transfer Control Protocol). When the packets are in the right order, the recipient combines the packets and receives the piece of information to be transmitted. In some cases, it is possible to generate a permanent virtual circuit (PVC, Permanent Virtual Circuit) which is defined in the standards ETS 300 048 and ETS 300 049, in which case a logical connection is allocated between the sender and the recipient. The arrangement resembles the fixed line in which there is a permanent allocated physical connection in the telecommunication network. However, it must be noticed that it is possible to divide the resources of a permanent virtual circuit between other users. The packet-switched traffic is being transferred by means of packet channel connections.

The monitoring is used to mean the testing of a channel connection in such a way that the channel connection in question is being monitored, as a consequence of which it is found out whether the channel is engaged. If the channel connection is engaged, it may, in addition, be found out whether the channel has got a speech or packet channel connection.

One specific problem associated is the allocation of channel connections dynamically. The number of packet channel connections is changing with the time, so it would be advantageous, if the capacity of the system was optimized. It is possible to divide the pulse code modulation channel connections between speech-and packet channels, so if the connection capacity of packet channels was spared, then it would be possible to offer a wider capacity to the speech channels. At present, the pulse code modulation speech- and packet channel connections are dimensioned according to the estimated amount of subscriber traffic, in which case too many resources may be allocated, and the valuable pulse code modulation cable connection is wasted at the same time. Often the pulse code modulation cable connections, which may be either underground cables or those hired from other operators, are a question of money to the network connection operators.

Previously known is a solution in which the number of packet channel connections of a system is estimated in advance. And the system is adjusted according to this. The previous solution does not enable the allocation of packet channels dynamically in accordance with the capacity needed.

The objective of the present invention is to eliminate or at least to alleviate the drawbacks referred to above. One further objective of the invention is to enable a remarkably simple method for the dynamical allocation of packet connection channels.

### BRIEF DESCRIPTION OF THE INVENTION

The invention enables one to dynamically allocate packet connection channels. If there is a need for more packet connection channels, then it is found out whether there is a free channel, and the channel is allocated to the packet channel connection. If there is a need for fewer packet connection channels, then the channel taken by the packet connection is released.

The invention relates to a method in which the need for packet channel connections is first estimated. If there are too few packet channel connections in use, then a new channel is allocated to the packet channel connection. Before allocating the channel it is checked whether there is traffic on the channel between the local exchange and the terminal device. If the channel is free, it is allocated to the packet channel connection. If on the other hand as the result of the comparison it is found out that there is a redundant packet channel connection in use, then the packet channel connection is released.

The ISDN packet-switched network service has been presented in the standards ETS 300 099, ETS 300 048 and ETS 300 049. Usually the local exchange has been connected to the remote subscriber stage by a pulse code modulation connection. The remote subscriber stage consists of one or more subscriber modules.

In conjunction with the creation of the subscriber module the operator sends a piece of information for establishing the packet connection. The finding out of a free time slot for the packet connection channel happens either in conjunction with the creation of the subscriber module or when the subscriber module starts. It is possible to allocate the packet channel connection also when the subscriber module is in operation. When the packet channel connection has been allocated, a notification informing of the chosen packet connection channel is sent along the signaling connection to the subscriber module.

The packet channel connection is maintained as long as it is possible within the limits of the system. Therefore, e.g. either the operator or a system failure may set down the packet channel connection. The system may also detect itself that the packet channel connection is no longer needed and set down the packet channel connection. In system failures, a new packet channel connection is first found out to substitute the lost one, and the subscriber module is informed of the new packet channel connection along the signaling connection.

If there are no free time slots available at once, the signaling connection of the subscriber module is used as a packet channel connection as long as a channel of its own is found out for the packet-formed information. For finding out the packet channel connection and for the dynamical allocation of a connection, a monitoring unit is needed which is typically located in the remote subscriber stage.

In one advantageous embodiment of the invention, three pulse code modulation cables and four subscriber modules are connected to the remote subscriber stage. Three subscriber modules need a packet channel connection for the transmission of packet-formed information, so in conjunction with the creation command of the subscriber modules the operator sends a notification of the packet channel connections to the control-and management information of the system as well as to the management programs of the transmission channel. When the subscriber module is being activated, the management programs of the transmission channel monitor the bus of the subscriber module to find out a free time slot as presented by the invention.

As compared with the prior art the invention provides the advantage that the packet channel connections are being flexibly increased or decreased according to the traffic needed, in which case the resources of the system are not allocated too many. Further, the invention enables the fact that there may be one or more packet channel connections per subscriber module. On the other hand, as a packet channel connection it is possible to use only the signaling channel of the subscriber module. The increasing or eliminating of packet channel connections happens without interruptions in the traffic. There is no need for allocating standby channels for the subscriber modules of the remote subscriber stage in case of a connection break-down. In that case, the operation of the exchange is getting simpler because in failure situations there is no need for allocating or releasing packet channel connections and their standby channels. The invention also adds to the utilization of the pulse code modulation cables, thus cutting down the operating costs of the pulse code modulation cables.

### BRIEF DESCRIPTION OF THE DRAWINGS

In the following section, the invention will be described by the aid of the attached examples of its embodiments with reference to the attached drawing, in which

FIG. 1 represents one system in accordance with the invention;

FIG. 2 represents a flow chart of the method in accordance with the invention;

FIG. 3 represents one embodiment in accordance with the invention; and

FIGS. 4, 5, 6, 7 and 8 represent one signaling diagram in accordance with the invention.

### DETAILED DESCRIPTION OF THE INVENTION

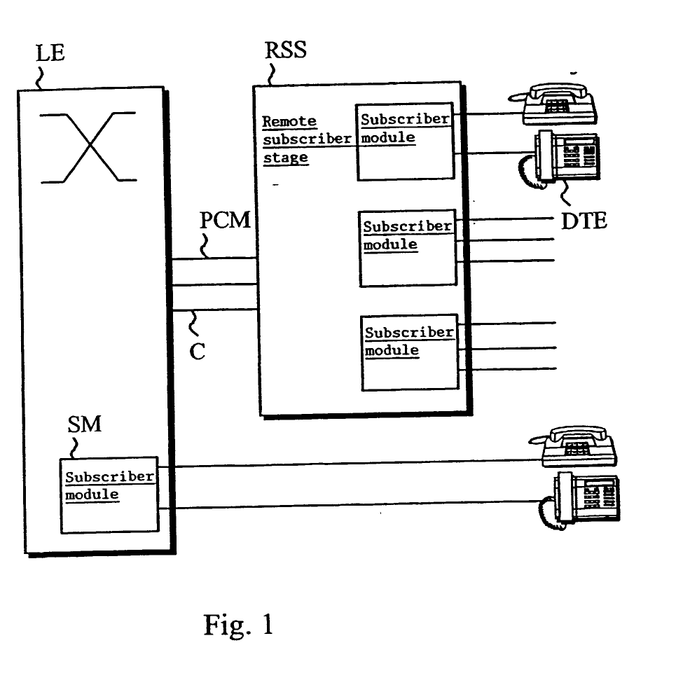

FIG. 1 represents one system in accordance with the invention. The exchange LE has been connected with three pulse code modulation PCM links to the remote subscriber stage RSS. Further, the remote subscriber stage RSS consists of three subscriber modules SM from which there is a connection to the subscribers of the telecommunication network.

In conjunction with the command to create the subscriber modules the operator sends a notification of the number of the packet channel connections to the control-and management information of the system as well as to the management programs of the transmission channel. When the subscriber module is being started, the transmission channels monitor the bus of the subscriber module in question to find a free time slot of which the subscriber module and the signaling terminal (AS7, Adapter for CCITT no. 7. LAPD functions) are informed. When the packet channel connection has been found out, a two-way connection is performed between the time slot coming from the subscriber module and the one coming from the management unit of the signaling slots of the call control unit. The programs of the subscriber module are informed of the time slot that is used as the packet channel connection. If the pulse code modulation cable of the remote subscriber stage, in which one or more packet channel connections are transported, is damaged, then the signaling programs of both the exchange and the subscriber module are informed of the corruption, in which case the damaged packet channel connections are set down and new ones are found out to substitute them, and a notification of them is sent to the subscriber modules.

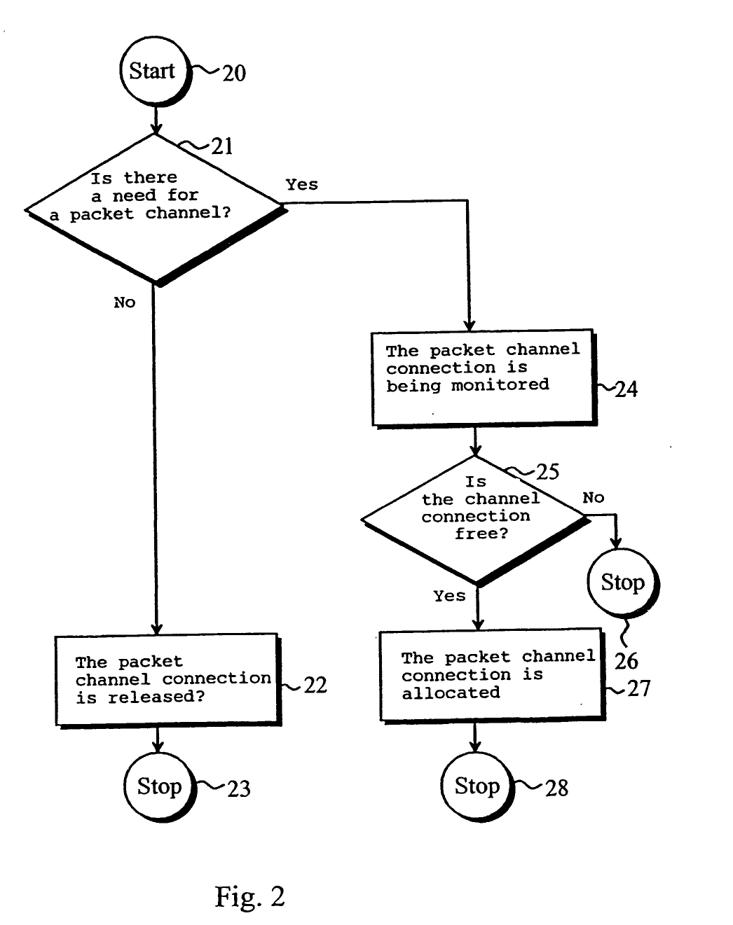

FIG. 2 represents one diagram of the method in accordance with the invention. At first, it is decided if there is a need for more packet connection capacity, block 21. If there is too much packet connection capacity and the channel connection has been allocated to the packet channel connection, then the packet channel connection is released, blocks 22 and 23. If on the other hand there is a need for more packet connection capacity, the channel connection is monitored and if the channel connection is free, then the channel is allocated to the packet channel connection, blocks 24, 25, 26, 27 and 28.

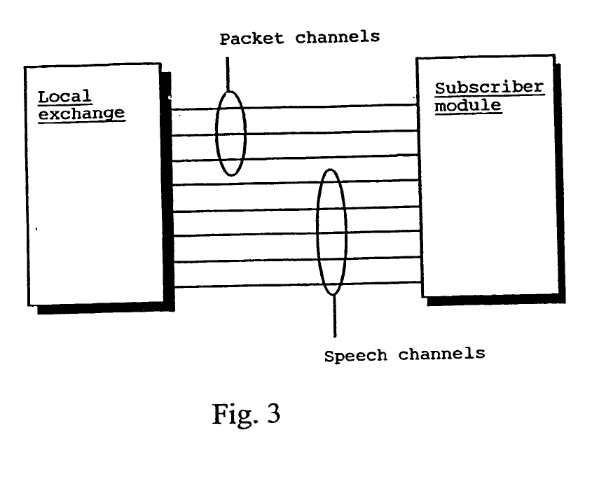

FIG. 3 represents one embodiment in accordance with the invention. The local exchange has been connected by a pulse code modulation link to the subscriber module. The pulse code modulation link of the example has got eight time slots at its disposal three of which are reserved to be used as packet channels and five are used as speech channels. The packet channels are monitored as shown by the invention.

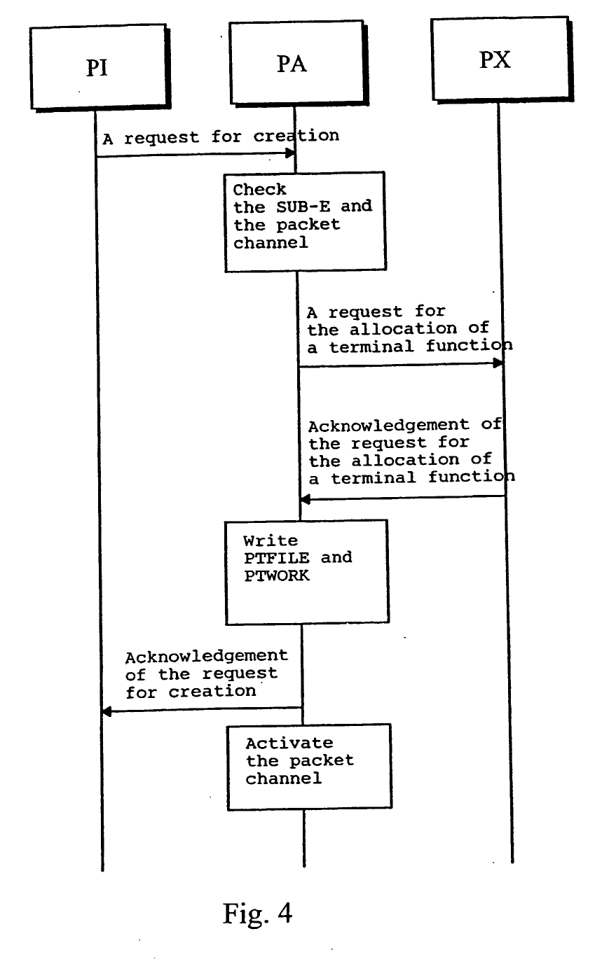

FIG. 4 represents one signaling diagram in accordance with the invention that describes the building of a packet channel. When the packet channel is built, a message is sent to three modules of the exchange; to the packet channel handling program (Packet Channel Handling Program) PI, to the P-type channel manager program block (P-type Channel Manager Program Block) PA and to the primary rate access D-channel manager (Primary Rate Access D-channel Manager) PX. At first, the packet channel handling program PI sends a command to create a packet channel to the P-type channel manager program block PA, which upon receiving the request, checks if the subscriber module in question (Subscriber Module) SUB-E and the packet channel already exist. If there is a subscriber module already existing and the packet channel has not been built, then a request for the allocation of a function of a terminal is sent to the primary rate access D-channel manager PX, which upon receiving the request for allocation allocates a terminal at the signaling terminal AS7 and sends an acknowledgement of the request for allocation back to the primary rate access D-channel manager PX. Finally, files PTFILE (P-channel configuration file) and PTWORK (Packet Channel Work file) are written to which information is saved relating to the packet channel; an acknowledgement message is sent to the packet channel handling program PI, and the activating of the packet channel is started.

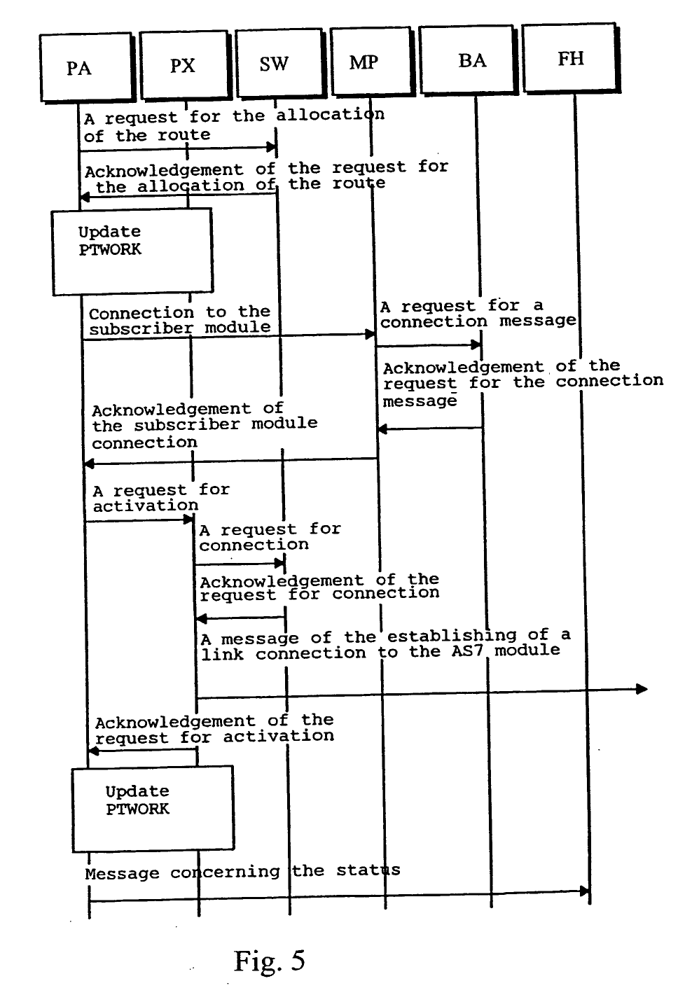

FIG. 5 represents one signaling diagram in accordance with the invention in which the packet channel is activated. In activating the packet channel, the following modules are needed; the P-type channel manager program block PA, primary rate access D-channel manager PX, switching program block SW, ISDN signalling program block (ISDN Signalling Program Block) MP, B-channel manager in SUB-E) (B-channel Manager in SUB-E) BA and frame handler manager program block (Frame Handler Manager Program Block) FH. At first, the PCM link and the time slot are allocated, of which a request for the allocation of a route is sent from PA to SW, to which SW replies with an acknowledgement message. After allocating the PCM link and the time slot, the work file of the packet channel PTWORK file is updated based on the information of the SW module. Next, PA asks the MP module for the connection to the subscriber module. MP sends the connection message request further to the BA module, which switches the time slots of the internal and external PCM links. When BA has performed the switching, it sends an acknowledgement message to the MP module, which for its part sends an acknowledgement message to the PA module. Upon receiving the acknowledgement message PA sends a request for the activation of the packet channel to PX. PX sends the switching request further to the SW module, which switches the time slot of the PCM link and an internal time slot at the signaling terminal AS7. In addition, a notification informing of the use of the operation of the terminal is sent to the signaling terminal AS7, after which SW sends an acknowledgement message to PA. Finally, PA updates the PTWORK file and informs the FH module of the link status of the packet channel.

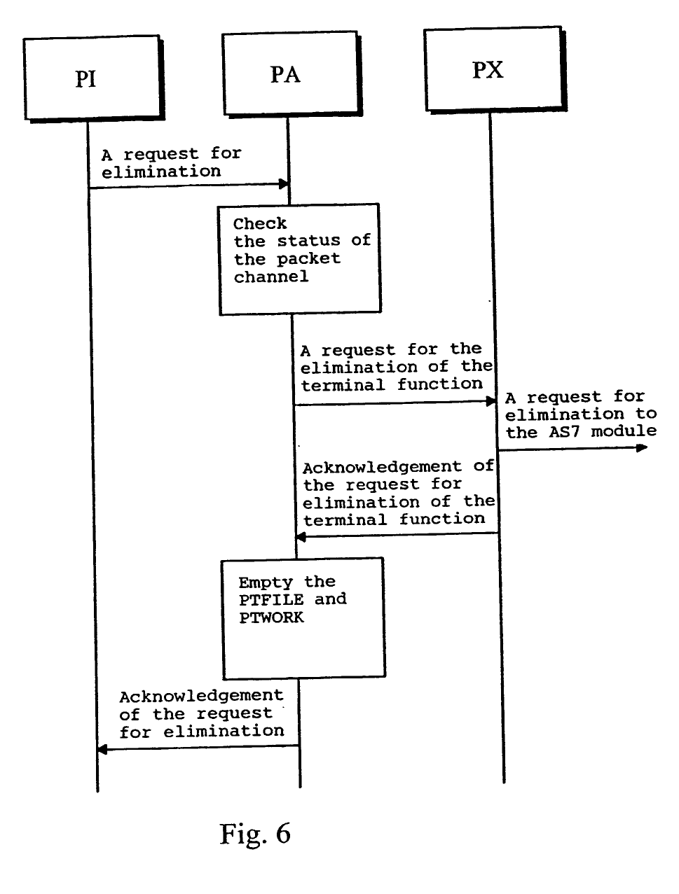

FIG. 6 represents one signaling diagram in accordance with the invention which describes the eliminating of a packet channel. When eliminating a signaling channel a message is sent to three modules of the exchange; the packet channel handling program PI, the P-type channel manager program block PA, and the primary rate access D-channel manager PX. At first, PI asks PA to eliminate a packet channel. PA checks the status and the existence of the packet channel from the PTFILE file. If the packet channel exists and is switched, then PA deactivates the packet channel. If the packet channel exists but is not switched, then PA just sends a message to PX asking to release the function of the terminal. After the deactivation of the packet channel, PA asks PX to release the function of the terminal. PX notifies the signaling terminal AS7 of the fact that the terminal is no longer in operation. An acknowledgement message of the function is sent to PA, which after it empties the PTFILE and PTWORK files. Finally, an acknowledgement message is sent to PI.

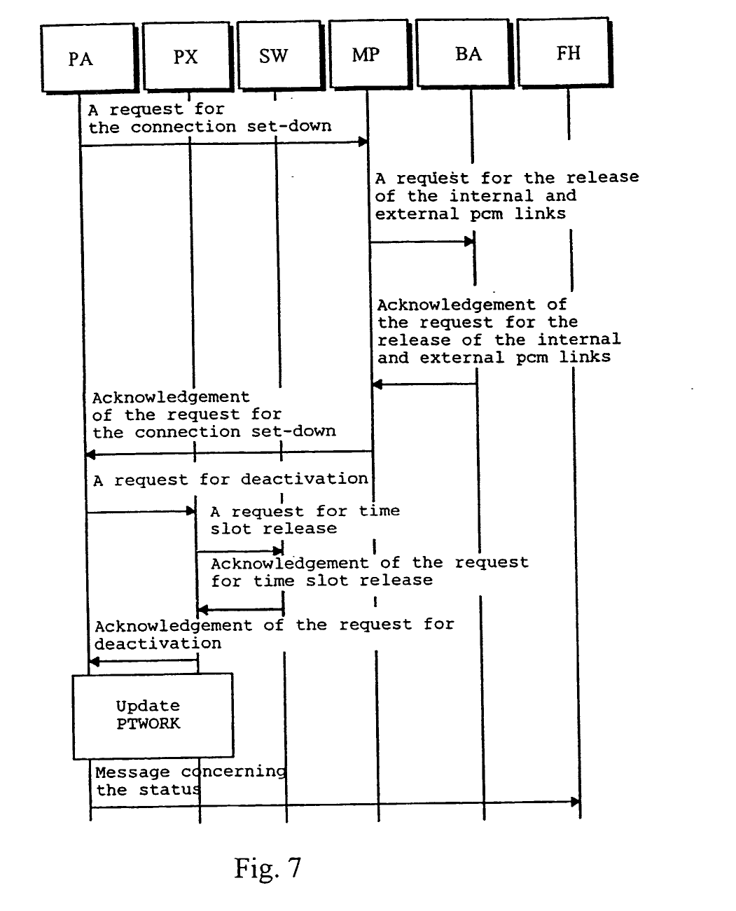

FIG. 7 represents one signaling diagram in which the packet channel is deactivated. The following modules are needed in deactivating the packet channel; the P-type channel manager program block PA, primary rate access D-channel manager PX, switching program block SW, ISDN signalling program block (ISDN Signalling Program Block) MP, B-channel manager in SUB-E) (B-channel Manager in SUB-E) BA and frame handler manager program block (Frame Handler Manager Program Block) FH. At first, PA sends a connection set-down request to the MP module, which sends the message further to the BA module, which releases the internal and external time slot switching of the PCM links. When BA has released the switching, it sends an acknowledgement message to the MP module, which for its part sends an acknowledgement message to the PA module. Upon receiving the acknowledgement message PA asks PX to deactivate the function of the terminal. PX sends the request for the releasing of the time slot further to the SW module, which releases the time slot. An acknowledgement message informing of the time slot release is sent to PA. Finally, PA updates the work file PTWORK of the packet channel and notifies the FH module of the change in the status of the packet channel.

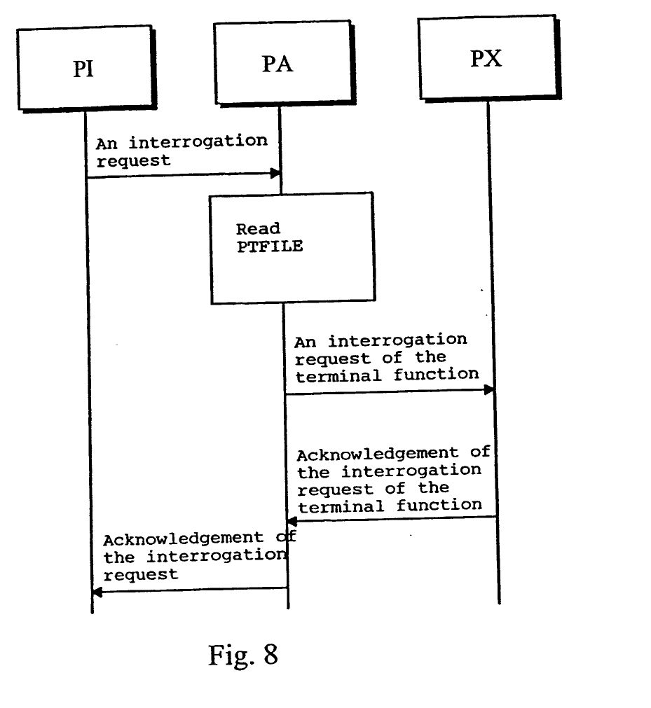

FIG. 8 represents one signaling diagram in accordance with the invention which describes the interrogation of the packet channel of a certain subscriber module. When interrogating the packet channel three modules of the exchange are signaled; the packet channel handling program PI, the P-type channel manager program block PA, and the primary rate access D-channel manager PX. At first, PI sends an interrogation request to PA. PA seeks for the packet channel in question from the PTFILE. If the packet channel is found, then a query is sent from the packet channel to the PX module to which the PX replies by sending the information connected with the aforementioned terminal. PA collects the acknowledgement message which includes information of the terminal and the unit, the number and status of the packet channel, and the time slot of a pulse code modulation connection. Finally, the acknowledgement message of the interrogation request is sent to the PI module.

The invention is not restricted merely to the examples of its embodiments referred to above, instead many variations are possible within the scope of the inventive idea defined by the claims.

1. A method for the allocation of channel connections of an integrated services digital network (ISDN) in a telecommunication system comprising:
a local exchange (LE);
a connection (C) which contains a group of channels that have been arranged to be dynamically allocated; and
a terminal device (DTE) which has been connected to the local exchange (LE) by the connection (C), in which method:
a connection is established between the local exchange (LE) and the terminal device (DTE),
characterised in that the method comprises the steps of:
comparing the number of packet channel connections in use with the number of packet channels needed.
in response to the comparison, a channel reserved for the packet channel connection is released, if there are packet channels in use more than needed; and
in response to the comparison, a free channel is found out and reserved for the packet channel connection, if there are too few packet channels in use.

2. A method as defined in claim 1, characterised in that a packet-formed network service (PMBS) of the integrated services digital network (ISDN) defined by the standards ETS 300 099, ETS 300 048 and ETS 300 049 is used.

3. A method as defined in claim 1 or 2, characterised in that the aforementioned terminal device (TE) is connected by a subscriber module to the aforementioned local exchange (LE).

4. A method as defined in claim 1, 2 or 3, characterised in that one or more remote subscriber stages (RSS) are connected to the local exchange (LE), and the aforementioned remote subscriber stage is connected by one ore more pulse code modulation links (PCM) to the aforementioned local exchange.

5. A method as defined in claim 1, 2, 3 or 4, characterised in that a notification is given of the fact that the aforementioned subscriber module (SM) needs a packet channel connection, when the subscribe module is being pre-programmed.

6. A method as defined in claim 1, 2, 3, 4 or 5, characterised in that a time slot is found out for the packet channel connection in conjunction with the pre-programming of the aforementioned subscriber module (SM).

7. A method as defined in claim 1, 2, 3, 4, 5 or 6, characterised in that a time slot is found out for the packet channel connection, when the aforementioned subscriber module (SM) starts.

8. A method as defined in claim 1, 2, 3, 4, 5, 6 or 7, characterised in that a time slot is found out for the packet channel connection, when the aforementioned subscriber module SM) is in operation.

9. A method as defined in claim 1, 2, 3, 4, 5, 6, 7 or 8, characterised in that the piece of information of the chosen packet channel connection is transferred to the aforementioned subscriber module via the signaling connection.

10. A method as defined in claim 1, 2, 3, 4, 5, 6, 7, 8 or 9, characterised in that the packet channel connection is set down, when the operator sends a notification of the connection set-down.

11. A method as defined in claim 1, 2, 3, 4, 5, 6, 7, 8, 9 or 10, characterised in that the packet channel connection is set down, when the system detects a failure and sends a notification of the connection set-down.

12. A method as defined in claim 1, 2, 3, 4, 5, 6, 7, 8, 9, 10 or 11, characterised in that the packet channel connection is set down, when the system detects that the packet channel connection is no longer needed.

13. A method as defined in claim 1, 2, 3, 4, 5, 6, 7, 8, 9, 10, 11 or 12, characterised in that a time slot is found out for the packet channel connection, and the aforementioned subscriber module (SM) is notified of the packet channel connection via the signaling connection, when the system detects a failure in the packet channel connection and sets down a corrupted packet channel connection.

14. A method as defined in claim 1, 2, 3, 4, 5, 6, 7, 8, 9, 10, 11, 12 or 13, characterised in that the signaling connection of the aforementioned subscriber module (SM) is used as a packet channel connection, if there are no free time slots available.

15. A method as defined in claim 1, 2, 3, 4, 5, 6, 7, 8, 9, 10, 11, 12, 13 or 14, characterised in that the data transmission channel is used, if there are no free time slots.

16. A system for the monitoring of a packet channel of a piece of packet information of an integrated services digital network (ISDN) in a telecommunication system which comprises:
a local exchange (LE);
a connection (C) which contains a group of channels which have been arranged to be dynamically allocated; and
a terminal device (DTE) which has been connected to the local exchange (LE) by the connection (C), in which system:
a connection is established between the local exchange (LE) and the terminal device (DTE).
characterised in that the system comprises:
a monitoring unit which comprises a piece of equipment for the monitoring of a packet channel of an integrated services digital network (ISDN) and for the allocation of it between different resources.
